(19) United States
(12) Patent Application Publication
(10) Pub. No.: US 2008/0309812 A1
(43) Pub. Date: Dec. 18, 2008

(54) CAMERA MODULE

(75) Inventors: YING-LIN CHEN, Tu-Cheng (TW); YUNG-CHOU CHEN, Tu-Cheng (TW); SU-JEN CHENG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/925,317

(22) Filed: Oct. 26, 2007

(30) Foreign Application Priority Data
Jun. 15, 2007 (CN) 200710200826.2

(51) Int. Cl. H04N 5/225; H04N 5/222

(52) U.S. Cl. 348/340; 348/373; 348/E05.026

(57) ABSTRACT

A camera module includes a lens module including a holder and configured for imaging, an image sensor module received in the holder of the lens module and configured for capturing images, and a protective film adhered to an outer surface of the lens module. Due to the protective film, the outer and inner screw threads of the barrel and the holder are insulated from the outside. As such, use of the protective film maintains the quality of image produced by the camera module.

### RELATED FIELD

The present invention relates to camera modules and, more particularly, to a camera module having a protective film.

### BACKGROUND

Increased production volumes in digital image technology are due not only to the increasing popularity of conventional digital cameras, but also due to miniature fixed-focused digital cameras incorporated into various end products, such as mobile telephones (cellular telephones), personal digital assistants (PDA), and other electronic devices.

However, during the manufacture and transport of digital camera modules, dust or liquid is often trapped within the digital camera module along screw threads or gaps in the camera modules. A dust particle of approximately 5 microns is large enough to cover an entire pixel of the image sensor resulting in a black dot appearing in images produced by the camera module. As result, it is desirable to prevent the dust particles from contacting the image sensor.

### SUMMARY

In accordance with a present embodiment, a camera module includes a lens module including a holder configured for imaging, an image sensor module received in the holder for capturing images, and a protective film adhered to an outer side of the lens module.

### BRIEF DESCRIPTION OF THE DRAWINGS

The present invention is described in detail hereinafter, by way of example only, through description of a preferred embodiment thereof and with reference to the accompanying drawings in which:

FIG. 1 is an exploded, isometric view of a camera module in accordance with a preferred embodiment of the present invention;

FIG. 2 is partial assembly view of FIG. 1; and

FIG. 3 is an assembled view of FIG. 1.

### DETAILED DESCRIPTION OF THE PREFERRED EMBODIMENTS

The detailed explanation of a camera module according to the present embodiment will now be made with reference to the drawings attached hereto.

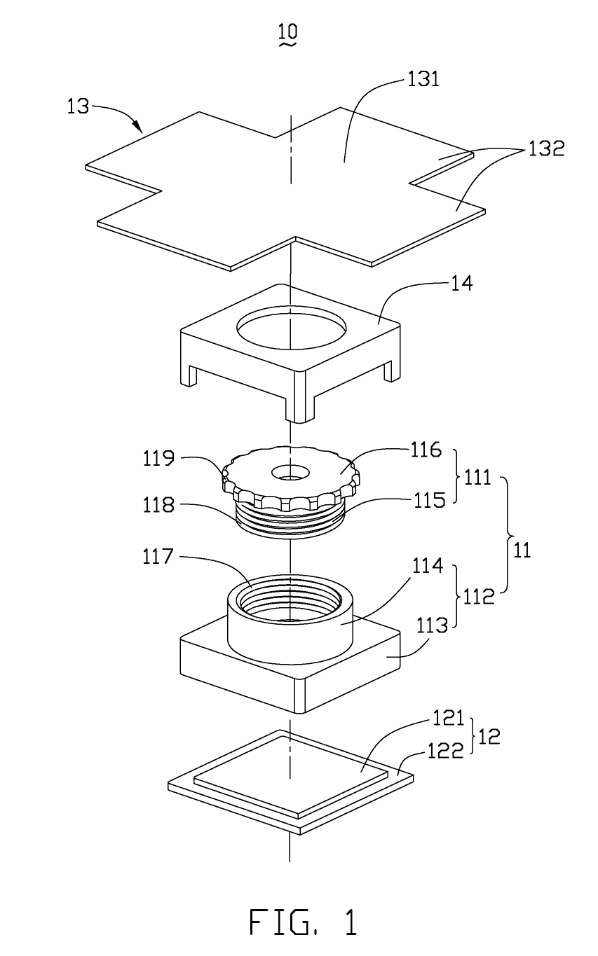

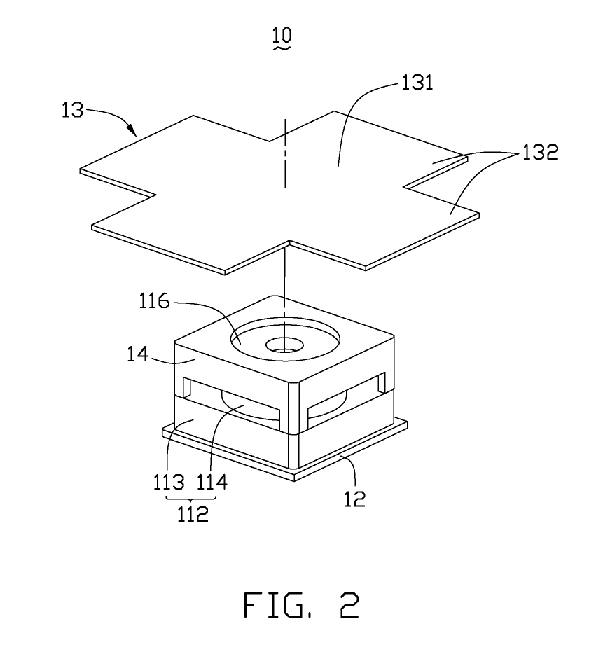

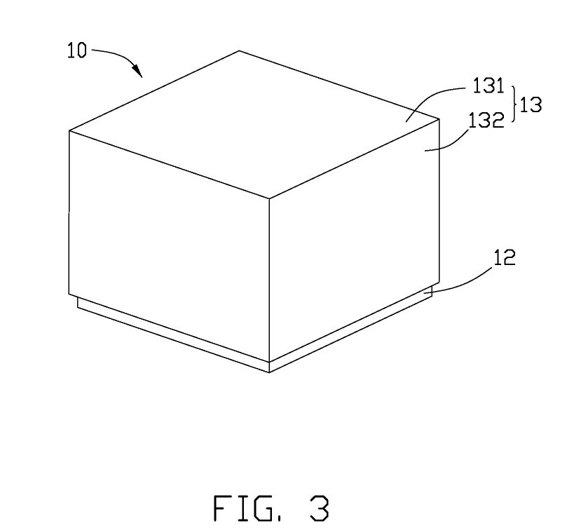

Referring to FIGS. 1-3, a camera module 10 for being used in conventional digital cameras or some other electronic device, such as mobile telephone, PDA, cellular phone, etc, is shown. The camera module 10 includes a lens module 11 configured for imaging, an image sensor module 12 engaged with the lens module 11 and configured for capturing images, and a protective film 13 adhered to the outer surface of the lens module 11.

The lens module 11 includes a barrel 111 configured for receiving a number of lenses (not shown) and a holder 112 connected to the barrel 111. The holder 112 includes a base portion 113 and an extension section 114. The base portion 113 includes four side walls cooperatively forming a rectangular chamber for receiving the image sensor module 12 therein. The extension section 114 has a columnar configuration and extends upward from the middle of the base portion 113 and defines an inner screw thread 117 therein. The barrel 111 defines a first annular portion 115 and a second annular portion 116. The first annular portion 115 defines an outer screw thread 118 configured for engaging with the inner screw thread 117 of the holder 112. The first annular portion 115 is hollow or tubular in order to receive the lenses therein. The second annular portion 116 defines a number of teeth 119 consistently spaced about the periphery of the second annular portion 116.

The image sensor module 12 includes an image sensor 121 and a base 122 configured for supporting the image sensor 121 and electrically connecting to the image sensor 121. The image sensor module 12 is configured for capturing images and converting the images into digital data to be processed by a processor (not shown). The image sensor module 12 is received in the rectangular chamber of the base portion 113.

The protective film 13 includes a body 131 configured for protecting the top side of the lens module 11 and four arms 132 extending outward from edges of the body 131 to protect the lateral sides of the lens module 11 respectively. The body 131 is integrated with the four arms 132 or is separate from the four arms 132. In the present embodiment, the body 131 is integrated with the four arms 132. The protective film 13 can be a masking tape (3M4734), and a glue is applied to the surface of the protective film 13 to bond the protective film 13 to the outer surface of the lens module 11. In assembling the camera module 10 with other electronic devices, such as cameras, the protective film 13 should be peeled from the lens module 11. It can be understood that if the protective film 13 is transparent, it doesn't need to be peeled from the lens module 11 after assembling the camera module 10.

It can be understood that the camera module 10 can also include a drive device 14 disposed in the top side of the lens module 11. As well known, the drive device 14 can be a voice coil motor and is coupled to the second annular portion 116 of the barrel 111 in order to cooperate with the teeth 119 to adjust the focus of the lens module 11. Because dust or liquid can trapped within the image sensor chip 121 along gaps between the drive device 14 and the lens module 11, the protective film 13 is adhered to the outer sides of the drive motor 14 and the lens module 11.

As described above, due to the protective film 13, the outer, inner screw threads 118, 117 of the barrel 111 and the holder 112 are protected. Therefore, dust or liquid cannot fall onto the image sensor module 12 through any gap that may exist between the outer screw thread 118 and the inner screw thread 117 during manufacture and transport. Therefore, the protective film 13 prevents the dust particles from contacting and adhering to the image sensor module 12. As result, reliable image quality of the camera module is obtained.

It can be understood that the above-described embodiment are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A camera module, comprising:
a lens module configured for imaging, the lens module comprising a holder;
an image sensor module comprising an image sensor and a base supporting the image sensor thereon and electrically connecting to the image sensor, the image sensor being received in the holder of the lens module and configured for capturing images, and
a protective film adhered to the outer side of the lens module to enclose the lens module and the image sensor together with the base.

2. The camera module as claimed in claim 1, wherein a surface of the protective film has adhesive applied thereon for adhering the protective film to the outer side of the lens module.

3. The camera module as claimed in claim 1, wherein the protective film is a masking tape.

4. The camera module as claimed in claim 1, wherein the protective film comprises a body and four arms extending outward from edges of the body respectively.

5. The camera module as claimed in claim 4, wherein the body is integrally formed with the four arms.

6. The camera module as claimed in claim 4, wherein the body is separate from the four arms.

7. The camera module as claimed in claim 4, wherein the body is adhered to the topside of the lens module.

8. The camera module as claimed in claim 4, wherein the four arms are adhered to the lateral side of the holder of the lens module.

9. The camera module as claimed in claim 8, wherein edges of the arms away from the body contact with the base of the image sensor module.

10. The camera module as claimed in claim 7, further comprising a driving device configured for adjusting the focus of the lens module and disposed in the top side of the lens module.

11. The camera module as claimed in claim 10, wherein the driving device is a voice coil motor.

12. The camera module as claimed in claim 10, wherein the protective film is adhered to the outer sides of both the lens module and the driving device.
